(19) United States
(12) Patent Application Publication
(10) Pub. No.: US 2016/0369477 A1
(43) Pub. Date: Dec. 22, 2016

(54) Tool Module for Heavy Equipment

(71) Applicant: Kegan J. Lance, Midway, UT (US)

(72) Inventor: Kegan J. Lance, Midway, UT (US)

(21) Appl. No.: 15/187,637

(22) Filed: Jun. 20, 2016

Related U.S. Application Data
(60) Provisional application No. 62/230,838, filed on Jun. 18, 2015.

(51) Int. Cl. E02F 3/96; B66C 23/36

(52) U.S. Cl. CPC E02F 3/964; E02F 3/963; B66C 23/36

(57) ABSTRACT

A self-contained, fully functional modular crane attachment is meant for use on any piece of carrier equipment with hydraulics capable of operating it in place of a bucket attachment mechanism to turn carrier into a crane. The attachment is comprised of a main frame that runs parallel with the ground before angling upward. At the start of the attachment is a universal bolt plate meant to except any form of quick coupler plate or pin attachment so as to attach the attachment to any appropriate carrier machine. On top of the frame sits the hydraulic tool, which may be a winch, pole lifter, tree cutter, or other such tool. Finally, on the end of the frame furthest from the mounting plate may be a series of head pulleys that may direct a cable into the vertical axis for lifting.

### CROSS-REFERENCES TO RELATED APPLICATIONS

This Application claims priority under 35 USC 119(e)(3) as a non-provisional perfection of prior filed U.S. Application No. 61/230,838, filed Thursday, Jun. 18, 2015, and incorporates the same by reference herein in its entirety.

### FIELD OF THE INVENTION

The present invention relates to the field of construction vehicles and more particularly relates to a modular attachment for such vehicles to add additional tool functionality to the vehicle.

### BACKGROUND OF THE INVENTION

Large construction vehicles are usually made with a specific purpose in mind. Accordingly, each vehicle has one or two tools with which it is made to accomplish its intended purpose. However, heavy equipment vehicles are particularly expensive, even cost prohibitive when considering some of the specialized functionality of certain vehicles. Each vehicle usually has a means of mounting and dismounting the tool. However, each vehicle brand has its own proprietary mounting mechanisms and usually only make a limited number of, usually similar, tool attachments for their vehicles. What is needed, then, is a modular tool attachment which is adaptable to not only a varied array of vehicles, but also to broaden the number of tools available for most vehicles.

A modular attachment that is meant to bridge the gap between a conventional machine and a crane or other tool will have modular adaptability not only in tools selection, but also in mounting structure. The primary goals are to reduce cost and increase effectiveness by creating a tool that can be utilized on multiple machines.

### SUMMARY OF INVENTION

A self-contained tool module with a hydraulic winch or other hydraulic tool may be used with heavy construction machines. Such attachment would be run from the cab of a carrier machine through hydraulic lines controlling the hydraulic winch or other tool. Currently many machines are being used as crane units for lifting and placement of materials. This module would increase control and safety of these operations. Other tools, including a pole lifter or tree cutter, may be used in place of or in cooperation with a winch.

By replacing the bucket or other standard tool of the carrier machine with the crane module the machine becomes a crane. Likewise, if a pole lifter module is used, the machine becomes a pole lifter, etc. The carrier machine's hydraulics then run the tool according to its purpose and according to the operator of the machine. When the module isn't in use it can be set on the ground and disconnected then the machine can reattach its bucket or other standard tool. A tool module may be designed in such away so that when it is removed from the machine none of the main components other than the frame will come into contact with flat ground.

Alternately, when the attachment is removed, it is intended that a two-plate mounting means include a mounting plate that can be removed and replaced by a mounting plate for any other machine the operators may have. Likewise, the tool itself may be modular. A hydraulic winch may be replaceable, or even supplemented, by another tool such as a pole lifter or tree cutter.

A modular tool as described represents a departure from the prior art in that the modular of the present invention allows for modular adaptability of the tool for mounting various alternative tools on existing carrier vehicles.

The more important features of the modular tool have thus been outlined in order that the more detailed description that follows may be better understood and in order that the present contribution to the art may better be appreciated. Additional features of the modular tool will be described hereinafter and will form the subject matter of the claims that follow.

Many advantages of the modular tool will appear from the following description and appended claims; reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of one embodiment of the invention, specifically a modular crane attachment, on a backhoe.

FIG. 2 is a perspective view of the modular crane attachment of FIG. 1.

FIG. 3 is an exploded view of the modular crane attachment of FIG. 2.

FIG. 4 is a perspective view of an attachment module, such as one used on the modular crane attachment of FIG. 2.

FIG. 5 is an alternate perspective view of the attachment module of FIG. 4.

FIG. 6 is a perspective view of an alternate attachment module.

FIG. 7 is an alternate perspective view of the attachment module of FIG. 6.

FIG. 8 is a perspective view of a further alternate attachment module.

FIG. 9 is an alternate perspective view of the attachment module of FIG. 8.

FIG. 10 is a perspective view of the modular crane attachment of FIG. 3, with a pole lifting module attached thereto.

FIG. 11 is a perspective view of a modular pole lifting attachment, with an extendable fiberglass arm.

### DETAILED DESCRIPTION OF THE PREFERRED EMBODIMENT

With reference now to the drawings, the preferred embodiment of the modular tool is herein described. It should be noted that the articles “a”, “an”, and “the”, as used in this specification, include plural referents unless the content clearly dictates otherwise. It should be noted that the preferred embodiment is depicted to be a winch or crane modular attachment; however, other tools may be incorporated other than a winch. These tools may be added to the basic winch embodiment disclosed, or may be separate embodiments, or may even be modular tool attachments, replacing the depicted winch. Limitations to only the winch embodiment, or even the tool options discussed herein, should not be inferred.

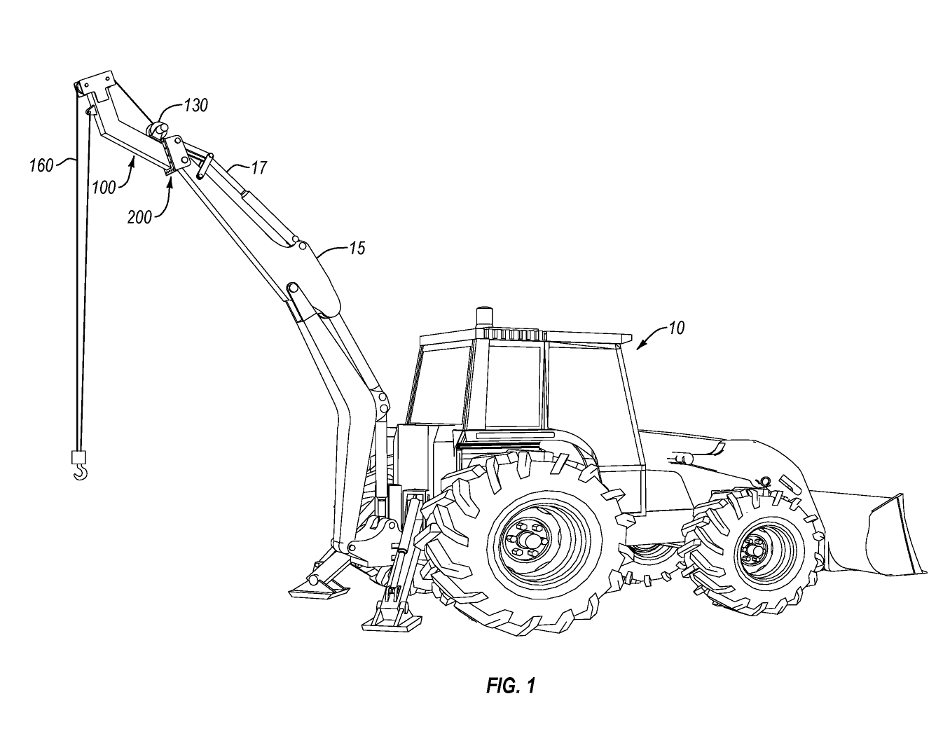

With reference to FIG. 1, a carrier vehicle, such as backhoe 10, has its primary tool replaced by a modular tool attachment, such as the winch attachment 100, depicted in FIG. 1. The backhoe 10 has the modular tool attachment 100 (in this case, a winch) mounted on its boom 15 and its hydraulic system 17 is operatively coupled to said modular tool attachment 100 so that the winch 130 and associated cable 160 may be operated by the vehicle driver. The modular tool attachment is connected to the backhoe arm 17 by a vehicle adapter 200 which is specifically designed to interface with that vehicle and securely hold the modular attachment 100 in place.

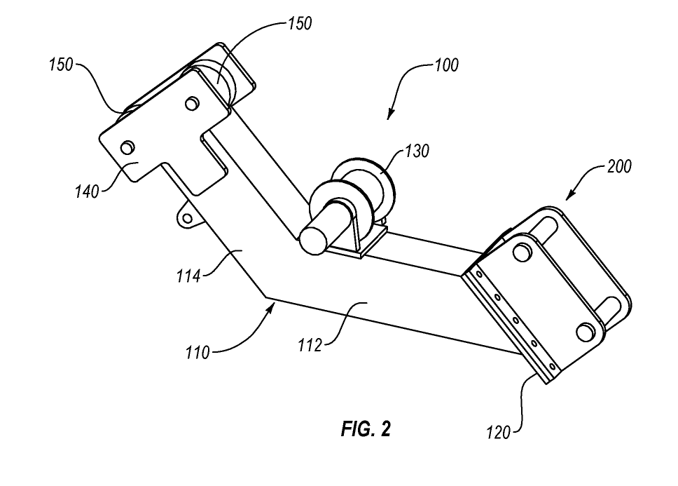

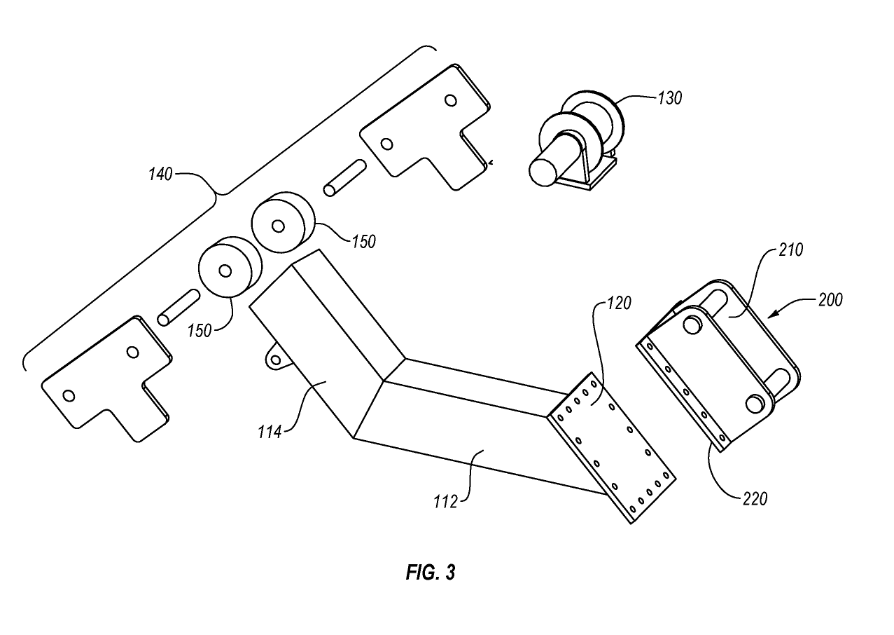

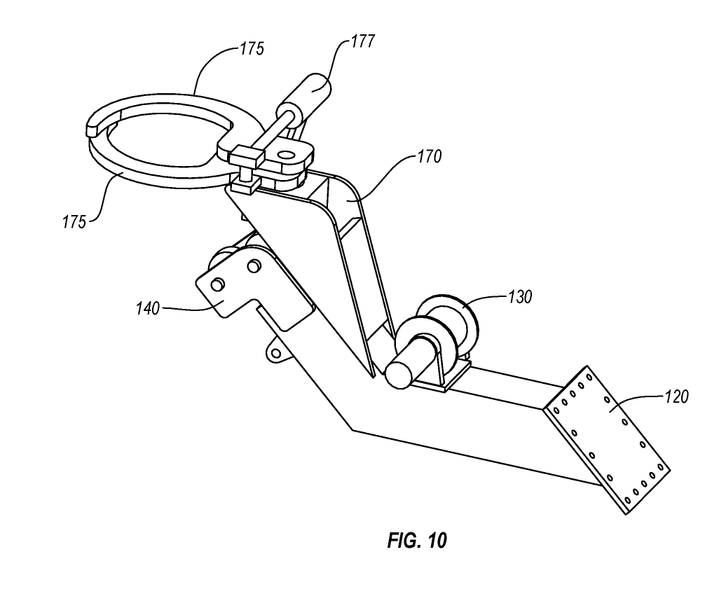

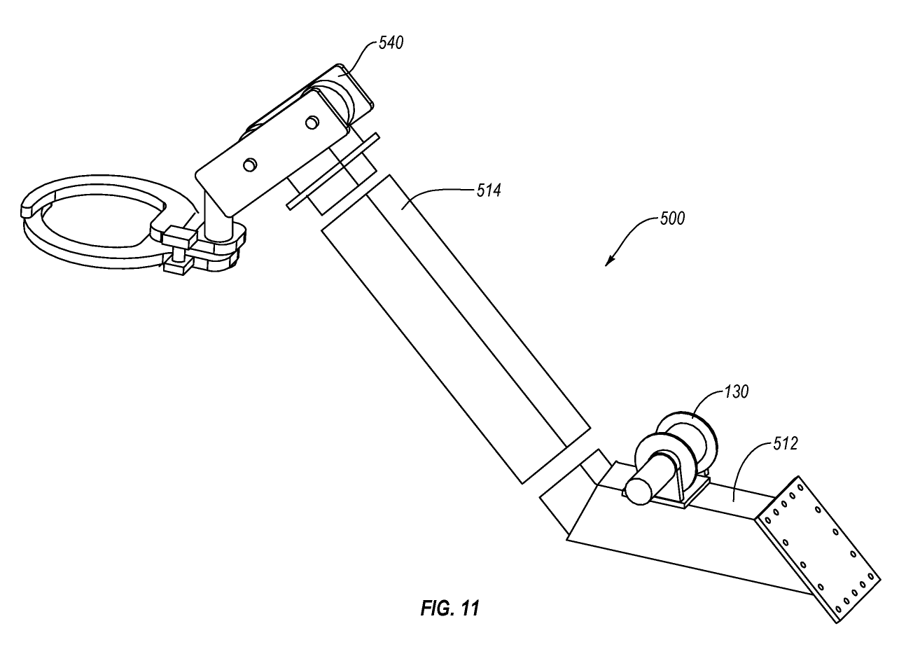

A closer inspection of the modular tool attachment 100 (FIGS. 2 and 3) show a simple construction of an attachment body 110 with a mounting plate 120 that interfaces with the vehicle adapter 200. The attachment body has two arms 112, 114 connected to each other at approximately a 135° angle. In this manner, when the attachment module is set upon the ground or other surface, the tool head 140 and head pulleys 150 will be raised off of the ground. The angled relationship also provides clearance for the winch 130 and the cable 160 to readily interface with the head pulleys 150. It should be understood that such an angle would not be necessary for those tools which would not require such clearance. As such, the invention may be practiced with a single arm, with no angle, or two or more arms with desired angular displacement. The vehicle adapter 200 is bolted to the mounting plate 120. While depicted as bolted, any means of secure but removable attachment may be utilized, whether known now or later discovered. Head 140 may also be removable. Other tools may also be added to the tool head, such as the pole lifter module 170 attached to the modular tool attachment in FIG. 10. With this particular tool module, control mechanisms 177 are interfaced with the existing control mechanisms of the vehicle to operate the two pinching arms 175.

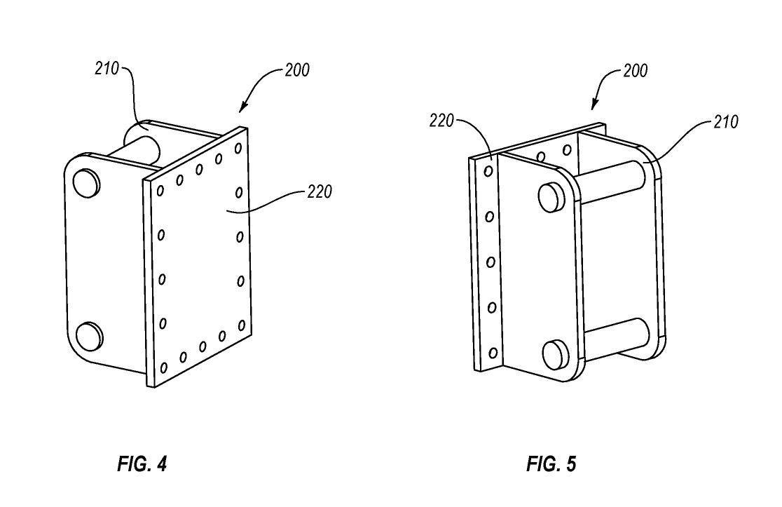

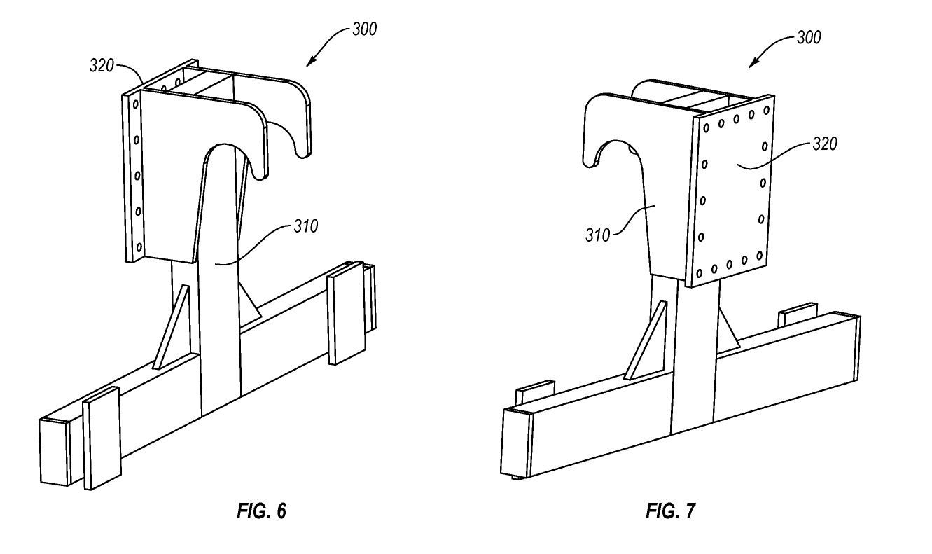

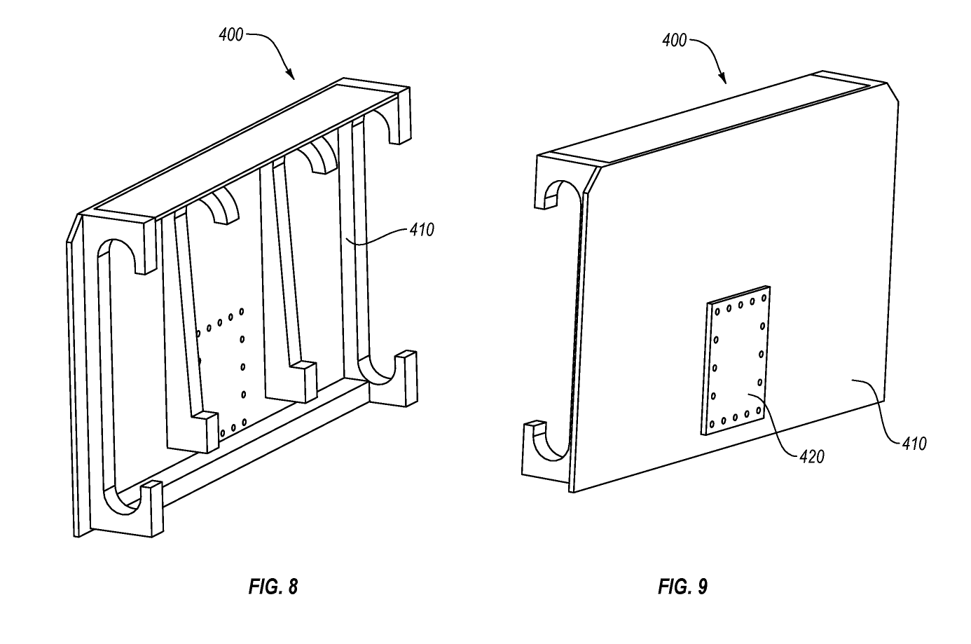

Various vehicle adapters may be made to fit onto the modular tool attachment. Three such adapters are illustrated in FIGS. 4-9. In each adapter, a vehicle adapter plate 220, 320, 420, is provided on a vehicle attachment structure 210, 310, 410. Each vehicle attachment structure is made to fit a given vehicle. In this manner, a user may purchase the adapter for one or two vehicles along with the modular tool attachment, saving financial resources by providing adaptability to the vehicles the user already has.

Another embodiment 500 of the invention is shown in FIG. 11. In this embodiment a different tool head 540, in this case a pole lifter, is positioned upon a modular extension arm 514 attached to base arm 512. The angle is preferred to be maintained as this would now better allow a modular arm attachment 514 to be mounted upon or removed from the base arm 512 and also still maintain the raised positioning of the head 540 when attachment is maintained. Other modifications to the invention include making one or the other of arms 512, 514 hydraulically extendable. Also integrating hydraulic ports and systems into the structure of the modular tool attachment may make attachment of various tool modules, such as depicted in FIG. 10, easier. As can be seen, many different tool heads may be developed and utilized with this invention. All that is required is for the tool head to be attachable to the upper arm structure 514. Of course, more complex tools, such as a tree cutter, will require more hydraulic pistons and controls, but these are easily adapted to the present invention. Hydraulic and other controls for such tool heads are easily adapted from the prior art. In this manner, tool heads may be replaced for maintenance or for increased functionality.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A modular tool attachment for a carrier vehicle, the attachment comprising:
a. an attachment arm with a mounting component on one side and a tool head on another;
b. a vehicle attachment adapter, attachable to the mounting component, said vehicle attachment adapter suited to physically interface the modular tool attachment to the carrier vehicle.

2. The modular tool attachment of claim 1, the mounting component being a mounting plate and the vehicle attachment adapter further comprising a vehicle adapter plate, said plated being fastened together to join the attachment arm and the vehicle attachment adapter.

3. The modular tool attachment of claim 2, the mounting plate and vehicle adapter plate being fastened together by a plurality of bolts.

4. The modular tool adapter of claim 3, the attachment arm being further comprised of 2 distinct arm components.

5. The modular tool adapter of claim 4, the two distinct arm components being removable from each other.

6. The modular tool adapter of claim 5, the two distinct arm components interfacing at an obtuse angle.

7. The modular tool adapter of claim 4, one arm component supporting the tool head being extendable.

8. The modular tool adapter of claim 4, the two distinct arm components interfacing at an obtuse angle.

9. The modular tool adapter of claim 4, the attachment arm being extendable.

10. The modular tool adapter of claim 4, the tool head being removable and replaceable with an alternate tool head.

11. The modular tool adapter of claim 4, the tool head being selected from the set of tool heads consisting of: a winch head, a pole lifter and a tree cutter.

12. The modular tool adapter of claim 1, the attachment arm being further comprised of 2 distinct arm components.

13. The modular tool adapter of claim 12, the two distinct arm components being removable from each other.

14. The modular tool adapter of claim 13, the two distinct arm components interfacing at an obtuse angle.

15. The modular tool adapter of claim 12, one arm component supporting the tool head being extendable.

16. The modular tool adapter of claim 12, the two distinct arm components interfacing at an obtuse angle.

17. The modular tool adapter of claim 12, the attachment arm being extendable.

18. The modular tool adapter of claim 12, the tool head being removable and replaceable with an alternate tool head.

19. The modular tool adapter of claim 12, the tool head being selected from the set of tool heads consisting of: a winch head, a pole lifter and a tree cutter.

20. The modular tool adapter of claim 1, the tool head being removable and replaceable with an alternate tool head.
